(19) United States
(12) Patent Application Publication
(10) Pub. No.: US 2014/0210442 A1
(43) Pub. Date: Jul. 31, 2014

(54) SWITCHING REGULATOR

(71) Applicant: DENSO CORPORATION, Kariya-city (JP)

(72) Inventor: Kazuhiro UMETANI, Nagoya-city (JP)

(73) Assignee: DENSO CORPORATION, Kariya-city (JP)

(21) Appl. No.: 14/157,712

(22) Filed: Jan. 17, 2014

(30) Foreign Application Priority Data
Jan. 29, 2013 (JP) 2013-14480

(51) Int. Cl. H02M 3/156

(52) U.S. Cl. CPC H02M 3/156
USPC 323/282

(57) ABSTRACT

In a switching regulator, a power feed circuit section includes a reactor, a capacitor, and a switching circuit controlling power supply from a power supply source to the reactor. A reference command value generation portion generates a reference command value based on a physical quantity representing a state of the power feed circuit section. An adder adds a pseudo command value depending on a reactor current flowing in the reactor to the reference command value. A limiter limits at least one of an upper limit value and a lower limit value with respect to an adding result of the adder. A removing section removes a value corresponding to the pseudo command value from a processing result of the limiter. A control performing section controls a duty ratio of the switching circuit using a processing result of the removing section as a command value.

### CROSS REFERENCE TO RELATED APPLICATIONS

The present application is based on and claims priority to Japanese Patent Application No. 2013-14480 filed on Jan. 29, 2013, the contents of which are incorporated in their entirety herein by reference.

### TECHNICAL FIELD

The present disclosure relates to a switching regulator.

### BACKGROUND

As a control method of a switching regulator, a current mode control is known. In the current mode control, a detection result of a reactor current is incorporated in a feedback loop that controls a switching time based on an error signal indicating an error of a measured value with respect to a command value of an output voltage so as to control the reactor current in accordance with change in the output voltage.

In a switching regulator of outputting a constant voltage, a requested accuracy of an output voltage is high, and a sensitivity to detect a deviation of an output voltage from a target value is set to be high. Thus, the switching regulator is configured to detect the deviation of the output voltage from the target value through an integration circuit having a sufficiently large time constant so that a ripple voltage of an output smoothing capacitor does not adversely affect a feedback control. However, in this case, a large delay is generated by the time constant of the integration circuit until the reactor current follows a load change.

On the other hand, for example, JP-A-2005-51927 (hereafter, referred to as a patent document No. 1) discloses a control method in which a difference between a reactor current and a load current, that is, a change in load current is incorporated in a feedback loop so as to reflect a load change on the reactor current.

When focusing on a smoothing capacitor connected between output terminals, in a steady operation state without load change, a reactor current supplied from a reactor to a smoothing capacitor has the same magnitude as a load current supplied from the smoothing capacitor to the load. Thus, a capacitor current that charges and discharges the smoothing capacitor does not flow.

When a large load change occurs in the switching regulator in the steady operation state, a difference is generated between the reactor current and the load current until the reactor current follows the change. Thus, a capacitor current that charges and discharges the output smoothing capacitor temporarily flows due to the difference, and the output voltage changes.

The capacitor current does not directly affect an output quality differently from the output voltage. Thus, the capacitor current can be can be taken in a control system after smoothing with a small time constant compared with an error signal or without smoothing in some cases. Therefore, if the capacitor current is reflected on a control system, a delay is less like to be generated.

However, in a case where the capacitor current is taken in a control system as described above, the control system cannot detect the absolute magnitude of the reactor current. Thus, when a load changes rapidly and drastically, the switching regulator cannot prevent flow of an excessive reactor current. As a result, a protection design is difficult when the switching regulator is applied to products, and it is difficult to use in practical applications.

In other words, in a normal current mode control, a value proportional to the reactor current is reflected on a command value of a time ratio in the way of addition and subtraction. Thus, when a limiter is applied to the command value, an upper limit value and a lower limit value of the reactor current can be directly set. On the other hand, in the technique disclosed in the patent document No. 1, the value proportional to the capacitor current, which is the difference between the reactor current and the load current, is reflected on the command value of the time ratio in the way of addition and subtraction. Thus, even when the limiter is applied to the command value, the reactor current cannot be limited although the capacitor current can be limited.

### SUMMARY

It is an object of the present disclosure to provide a switching regulator that has a high responsivity to a load change and enables an easy protection design against an excessive reactor current.

A switching regulator according to an aspect of the present disclosure includes a power feed circuit, a reference command value generation portion, an adder, a limiter, a removing section, and a control performing section. The power feed circuit section includes a reactor, a capacitor, and a switching circuit. The reactor is connected to a power supply source. The capacitor is connected between two output terminals and is charged and discharged by electric current supplied from the reactor. The switching circuit controls power supply from the power supply source to the reactor.

The reference command value generation portion generates a reference command value based on a physical quantity representing a state of the power feed circuit section. The adder adds a pseudo command value depending on a reactor current flowing in the reactor to the reference command value. The limiter limits at least one of an upper limit value and a lower limit value with respect to an adding result of the adder. The removing section removes a value corresponding to the pseudo command value from a processing result of the limiter. The control performing section controls a duty ratio of the switching circuit using a processing result of the removing section as a command value.

The switching regulator enables an easy protection design against each of too-large positive and negative current.

### BRIEF DESCRIPTION OF THE DRAWINGS

Additional objects and advantages of the present disclosure will be more readily apparent from the following detailed description when taken together with the accompanying drawings. In the drawings:

FIG. 1 is a circuit diagram showing a switching regulator according to a first embodiment;

FIG. 2A is a diagram showing an example of a current detector, and FIG. 2B is a diagram showing an example of a circuit for calculating a voltage deviation;

FIG. 3 is a circuit diagram showing an example of a limiter;

FIG. 4 is a circuit diagram showing a switching regulator according to a second embodiment;

FIG. 5A is a diagram showing an example of a reference command value generation portion, and FIG. 5B is a diagram showing another example of a reference command value generation portion;

FIG. 6 is a circuit diagram showing a switching regulator according to a third embodiment;

FIG. 7 is a circuit diagram showing an example of a control signal generation circuit;

FIG. 8 is a circuit diagram showing a switching regulator according to a fourth embodiment;

FIG. 9A and FIG. 9B are circuit diagrams showing examples of a reference command value generation portion;

FIG. 10 is a circuit diagram showing a switching regulator according to a fifth embodiment; and

FIG. 11 is a circuit diagram showing a switching regulator according to a sixth embodiment.

### DETAILED DESCRIPTION

Embodiments of the present disclosure will be described below with reference to the drawings.

### First Embodiment

A switching regulator 1 according to a first embodiment of the present disclosure can be suitably applied to a chopper switching regulator that operates as a buck converter.

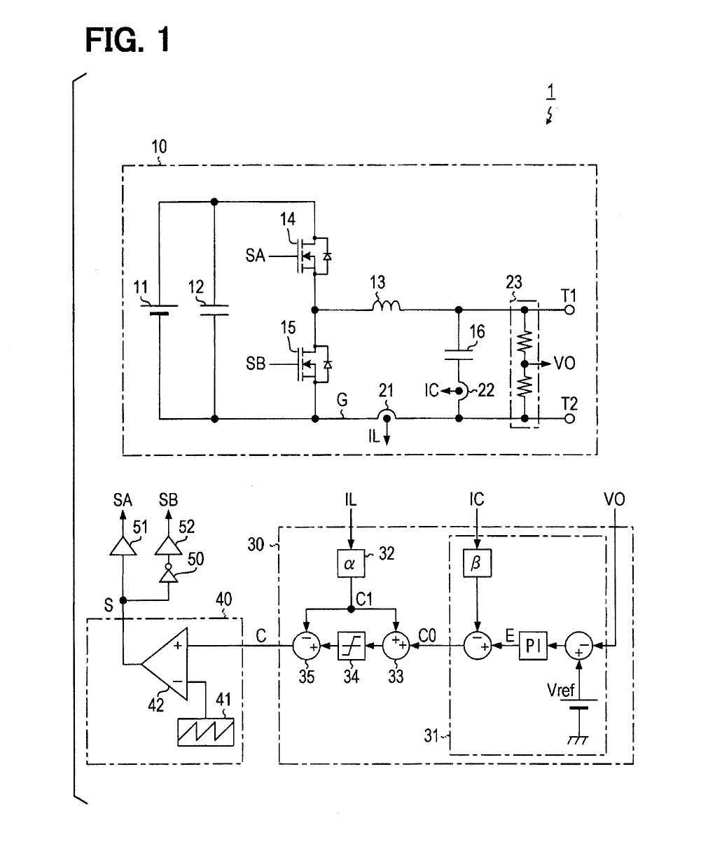

As shown in FIG. 1, the switching regulator 1 includes a power feed circuit section 10, a command value generation section 30, a control signal generation section 40, and an inverting circuit 50. The power feed circuit section 10 supplies electric power to a load at a predetermined target voltage. The command value generation section 30 generates a command value C based on a reactor current IL, an output voltage VO, and a capacitor current IC detected at the power feed circuit section 10. The control signal generation section 40 generates a switching signal S based on the command value C generated by the command value generation section 30. The inverting circuit 50 inverts the switching signal S. The switching signal S is supplied through a buffer 51 to the power feed circuit section 10 as a switching signal SA. An output of the inverting circuit 50 is supplied through a buffer 52 to the power feed circuit section 10 as a switching signal SB.

The power feed circuit section 10 includes a direct-current (DC) power source 11, a capacitor 12, a choke coil 13, a switching element 14, a switching element 15, and a capacitor 16. The DC power source 11 operates as a power supply source. The capacitor 12 is connected in parallel with the DC power source 11. The choke coil 13 is a reactor that is connected so as to form a closed circuit with the DC power source 11 and a load connected between output terminals T1, T2. The switching element 14 connects or disconnects a path from a positive electrode of the DC power source 11 to the choke coil 13 based on the switching signal SA. The switching element 15 connects or disconnects a path from a connection point of the switching element 14 and the choke coil 13 to a ground line G connected to a negative electrode of the DC power source 11 based on the switching signal SB. The capacitor 16 for smoothing is connected between the output terminals T1, T2. The switching element 14 is a known N-type field-effect transistor including a parasitic diode that enables electric current to flow from a source to a drain.

In addition, the power feed circuit section 10 includes a current detector 21, a current detector 22, and a voltage dividing circuit 23. The current detector 21 is disposed on the ground line G from the output terminal T2 to the negative electrode of the DC power source 11 and detects the reactor current IL that flows in the choke coil 13. The current detector 22 is disposed on a path from the capacitor 16 to the ground line G and detects the capacitor current IC that charges and discharges the capacitor 16. The voltage dividing circuit 23 includes a pair of resistors connected in series. The voltage dividing circuit 23 is connected between the capacitor 16 and the output terminals T1, T2. The voltage dividing circuit 23 generates the output voltage VO that is proportional to a voltage between the output terminals (i.e., a voltage across the capacitor 16).

The reactor current IL has a forward direction in a direction from the output terminal T2 to the negative electrode of the DC power source 11. The capacitor current IC has a forward direction in a direction charging the capacitor 16 so that a side adjacent to the output terminal T1 becomes plus.

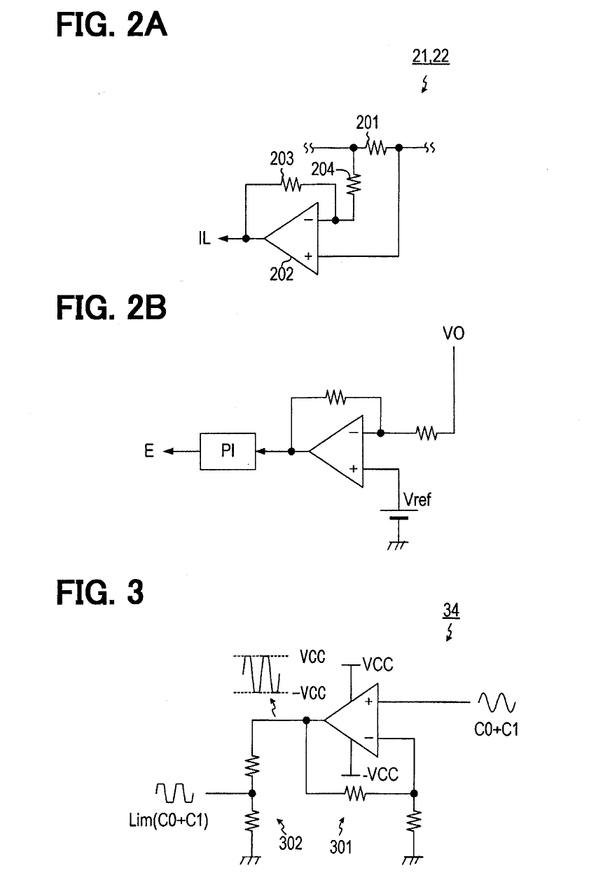

As shown in FIG. 2A, each of the current detectors 21, 22 is a known inverting amplifier circuit that includes a detection resistor 201, an operational amplifier 202, and resistors 203, 204. The detection resistor 201 is inserted in a current path in which electric current to be detected flows. One end of the detection resistor 201 is connected to a non-inverting input of the operational amplifier 202. The other end of the detection resistor 201 is connected to an inverting input of the operational amplifier 202 through the resistor 204. The resistor 203 is connected between the inverting input and an output of the operational amplifier 202. Each of the current detectors 21, 22 inverts and amplifies a voltage proportional to a magnitude of electric current to be detected and outputs the voltage.

In the power feed circuit section 10 having the above-described configuration, when the switching element 14 is on and the switching element 15 is off, electric current flows in a first closed circuit formed by the DC power source 11, the choke coil 13, and the load connected between output terminals T1, T2 (hereafter, this state is referred to as a first operation state). Accordingly, power supply to the load is performed, and electromagnetic energy is stored in the choke coil 13. On the other hand, when the switching element 14 is off and the switching element 15 is on, electric current flows in a closed circuit formed by the choke coil 13 and the load connected between the output terminals T1, T2 (hereafter, this state is referred to as a second operation state). In the second operation state, power supply to the load is performed by the electromagnetic energy stored in the choke coil 13.

The command value generation section 30 includes a reference command value generation portion 31, a pseudo command value generation portion 32, an adder 33, a limiter 34, and an adder 35. The reference command value generation portion 31 generates a reference command value C0 based on the output voltage VO and the capacitor current IC. The pseudo command value generation portion 32 generates a pseudo command value C1 corresponding to the reactor current IL multiplied by a factor α (in the present embodiment, α>0). The adder 33 adds the pseudo command value C1 to the reference command value C0. The limiter 34 limits an output of the adder 33 to a predetermined upper limit value when the output is greater than the upper limit value. The limiter 34 limits the output of the adder 33 to a predetermined lower limit value when the output is less than the lower limit value. The adder 35 generates the command value C by adding the pseudo command value C1 having an inverted polarity to an output of the limiter 34, that is, by subtracting the pseudo command value C1 from the output of the limiter 34. The adder 35 is an example of a removing section that removes a value corresponding to the pseudo command value C1 from a processing result of the limiter 34.

The reference command value generation portion 31 calculates a deviation of the output voltage VO with respect to a reference voltage Vref. The reference voltage Vref has a magnitude calculated by dividing a target voltage to be supplied to the load by the same voltage dividing ratio as the voltage dividing circuit 23. Then, the reference command value generation portion 31 generates an error signal E by performing a PI (integration, proportion) operation to the deviation. Furthermore, the reference command value generation portion 31 generates the reference command value C0 by subtracting a value corresponding to the capacitor current IC multiplied by a factor β from the error signal E. The deviation of the output voltage VO with respect to the reference voltage Vref can be obtained by a known differential amplifier circuit, for example, as shown in FIG. 2B.

In other words, the reference command value generation portion 31 is configured such that the smaller the output voltage becomes compared with reference voltage Vref or the more the capacitor current IC flows in a discharging direction (reverse direction), that is, the more the power supply becomes insufficient with respect to a power consumption of the load, the larger the reference command value C0 becomes.

The reference command value C0 is equivalent to the control value in the conventional device described in the patent document No. 1. In other words, in the steady operation state, because the capacitor current IC does not flow, the reference command value C0 changes depending on the error signal E. When the load current increases and the capacitor current IC flows in the discharging direction (reverse direction), the reference command value C0 increases. As a result, the reactor current IL rapidly increases, and the switching regulator 1 rapidly returns to the steady operation state in which the capacitor current IC does not flow. When the load current decreases and the capacitor current IC flows in the charging direction (forward direction), the reference command value C0 decreases. As a result, the reactor current IL rapidly decreases, and the switching regulator 1 rapidly returns to the steady operation state in which the capacitor current IC does not flow.

When the input value of the limiter 34 is denoted by X and the output value of the limiter 34 is denoted by Lim(X), the command value C generated by the adders 33, 35 and the limiter 34 from the reference command value C0 and the pseudo command value C1 can be expressed by equation (1). When the input value C0+C1 exceeds the upper limit value limited by the limiter 34, the switching signal S generated by the control signal generation section 40 is adjusted to have such a duty ratio that the reactor current IL does not exceed a predetermined upper limit value. When the input value C0+C1 falls below the lower limit value limited by the limiter 34, the switching signal S generated by the control signal generation section 40 is adjusted to have such a duty ratio that the reactor current IL does not fall below a predetermined lower limit value.

C=Lim(C0+C1)−C1 (1)

When the input value C0+C1 is within a limit range of the limiter 34, C=C0 and the switching regulator 1 achieves a control similar to the convention device.

When the input value C0+C1 exceeds the limit range of the limiter 34, the command value C has a magnitude obtained by subtracting the pseudo command value C1 from the limit value. Thus, the duty ratio is adjusted such that the pseudo command value C1 approaches the limit value. As a result, an upper limit and a lower limit are provided for the reactor current IL.

The functions of the command value generation section 30 and the control signal generation section 40 may be achieved by a combination of analog circuits or may be achieved by a digital operation process to a value obtained by ND conversions of the reactor current IL, the capacitor current IC, and the output voltage VO. The same applies to the following embodiments.

The control signal generation section 40 includes a saw-tooth wave generation circuit 41 and a comparator 42. The saw-tooth wave generation circuit 41 generates a saw-tooth wave. The comparator 42 generates a pulse width modulation (PWM) signal by comparing the saw-tooth wave generated by the saw-tooth wave generation circuit 41 with the command value generated by the command value generation section 30. The control signal generation section 40 outputs the PWM signal as the switching signal S.

When the command value C increases, a duty ratio of the switching signal S increases. Thus, electric power supplied from the DC power source 11 to the output terminals T1, T2 through the choke coil 13 increases with increase in the command value C and decreases with decrease in the command value C.

As described above, the switching regulator 1 generates the reference command value C0 based on the error signal E and the capacitor current IC. Thus, the switching regulator 1 can achieve control with high responsivity to load change.

In the switching regulator 1, the limiter 34 put limitations on a value obtained by adding the pseudo command value C1 proportional to the reactor current IL to the reference command value C0, and the pseudo command value C1 having the reversed polarity is added to the output value of the limiter 34 so as to offset the pseudo command value C1 reflected on the command value. Thus, the switching regulator 1 can put limitations on the reactor current IL with a simple configuration with keeping a characteristic (high responsivity to load change) of the reference command value C0.

Thus, the switching regulator 1 enables an easy protection design against each of too-large positive reactor current (i.e., excessive current flowing toward the load) and too-large negative reactor current (i.e., excessive current flowing from the load to the power source)

### Modification

The limiter 34 may set the upper limit value and the lower limit value within a range of power supply voltage provided to the limiter 34. Alternatively, as shown in FIG. 3, the limiter 34 may include a non-inverting amplifier circuit 301 and a voltage dividing circuit 302. The non-inverting amplifier circuit 301 is a known inverting amplifier circuit including an operational amplifier. The voltage dividing circuit 302 controls amplitude of an output of the non-inverting amplifier circuit 301. The output of the non-inverting amplifier circuit 301 is automatically limited to the power supply voltage±VCC and accordingly the upper limit value and the lower limit value are provided.

In the present embodiment, a value obtained by dividing a voltage between both ends of the output terminals T1, T2 by the voltage dividing circuit 23 is used as the output voltage VO. However, the voltage between both ends of the output terminals T1, T2 may also be used as the output voltage VO without processing. In this case, the target voltage itself may be used as the reference voltage Vref,

### Second Embodiment

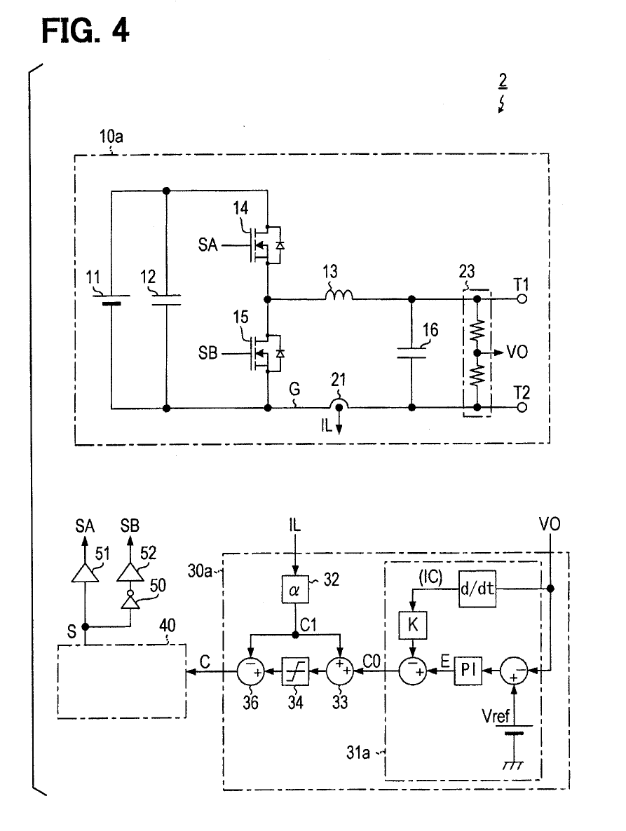

A switching regulator 2 according to a second embodiment of the present disclosure will be described below. As shown in FIG. 4, the switching regulator 2 includes a power feed circuit section 10a, a command value generation section 30a, a control signal generation section 40, an inverting circuit 50, and buffers 51, 52. Regarding configurations which have already been described above, the same reference numerals are attached, and a description will be omitted. A portion different from the above-described embodiment will be mainly described.

The power feed circuit section 10a has a configuration similar to the power feed circuit section 10 in the switching regulator 1 except that the current detector 22 for detecting the capacitor current IC is omitted. The command value generation section 30a has a configuration similar to the command value generation section 30 in the switching regulator 1 except for a reference command value generation portion 31a.

The reference command value generation portion 31a uses a value corresponding to a differential value of the output voltage VO multiplied by a factor K instead of a value corresponding to the capacitor current IC multiplied by the factor β as a value subtracting from the error signal E.

In other words, the switching regulator 2 uses a capacitor current calculated by differentiating the output voltage VO corresponding to the voltage across the capacitor 16 instead of the capacitor current IC detected by the current detector 22.

The switching regulator 2 having the above-described configuration can achieve effects similar to the switching regulator 1. In addition, because the number of the current detector can be reduced to one, the switching regulator 2 can achieve the effects with a simpler configuration.

### Modification

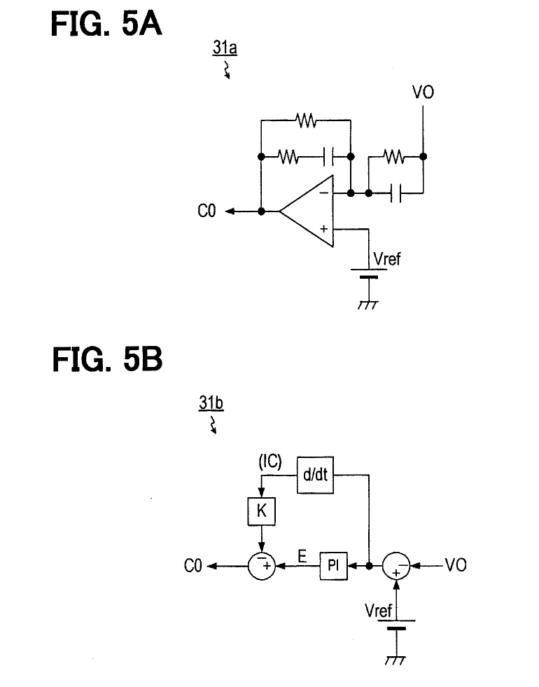

In a case where the reference command value generation portion 31a generates the reference command value C0 only from the output voltage VO, as shown in FIG. 5A, the reference command value generation portion 31a may be formed by a circuit using an operational amplifier in which a differential amplifier circuit, a differentiation circuit, and a filter circuit (integration circuit) are combined.

Alternatively, a reference command value generation portion 31b shown in FIG. 5B may be used. The reference command value generation portion 31b calculates the capacitor current by differentiating the deviation of the output voltage VO with respect to the reference voltage Vref instead of differentiating the output voltage VO.

### Third Embodiment

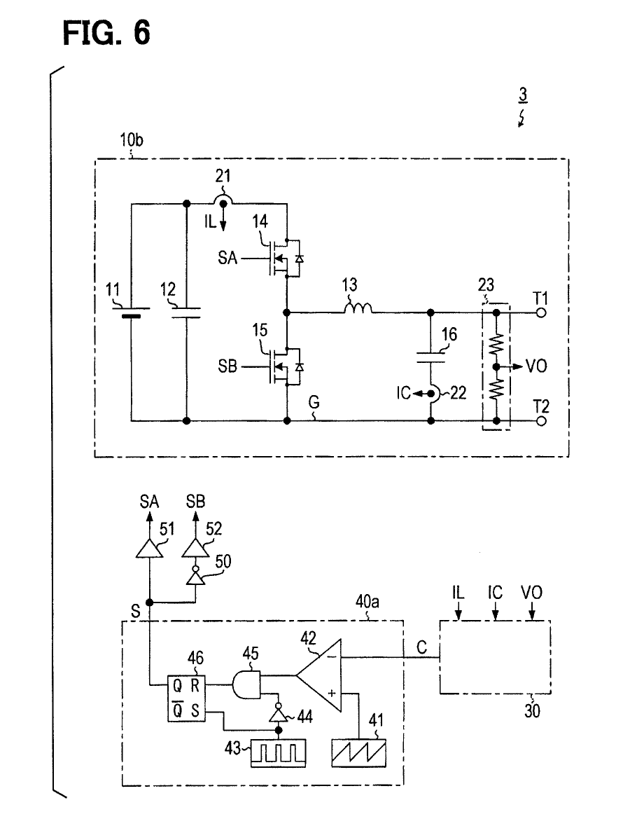

A switching regulator 3 according to a third embodiment of the present disclosure will be described below. As shown in FIG. 6, the switching regulator 3 includes a power feed circuit section 10b, the command value generation section 30, a control signal generation section 40a, the inverting circuit 50, and the buffers 51, 52. Regarding configurations which have already been described above, the same reference numerals are attached, and a description will be omitted. A portion different from the above-described embodiment will be mainly described.

The power feed circuit section 10b has a configuration similar to the power feed circuit section 10 in the switching regulator 1 except that the current detector 21 is connected between the DC power source 11 and the switching element 14 not on the ground line G. In other words, the reactor current IL can be detected only when the switching element 14 is on.

The control signal generation section 40a includes a pulse signal generation circuit 43, an inverting circuit 44, an AND circuit 45, and a RS flip-flop circuit 46 in addition to the saw-tooth wave generation circuit 41, and the comparator 42. The pulse signal generation circuit 43 generates a pulse signal synchronized with a period of the saw-tooth wave. The inverting circuit 44 inverts the pulse signal. The AND circuit 45 outputs a signal at high level when both of an output of the comparator 42 and an output of the inverting circuit 44 are high level. The RS flip-flop circuit 46 operates using the pulse signal as a set input and using an output of the AND circuit 45 as a reset input. A signal output from a positive output Q of the RS flip-flop circuit 46 is output as the switching signal S.

In the switching regulator 3 having the above-described configuration, if the switching signal S transitions to the high level at a time point when the pulse signal is output, the switching element 14 is turned on and the switching element 15 is turned off. While the switching element 14 is on, the reactor current IL is correctly detected by the current detector 21. Thus, the command value generation portion 30 normally operates and generates the command value C depending on the operation state of the power feed circuit section 10b.

After that, if the switching signal S transitions to the low level at a time point when the saw-tooth wave exceeds the command value C, the switching element 14 is turned off and the switching element 15 is turned on. While the switching element 15 is off, the current detector 21 cannot detect the reactor current IL correctly. However, because the command value generation section 30 does not have to operate until the pulse signal causes the switching signal S to transition to the high level again, a problem is not caused.

As described above, the switching regulator 3 according to the present embodiment can achieve effects similar to the switching regulator 1.

### Modification

The command value generation section 30a may be used instead of the command value generation section 30. When the command value generation section 30a is used, the current detector 22 for detecting the capacitor current IC may be omitted.

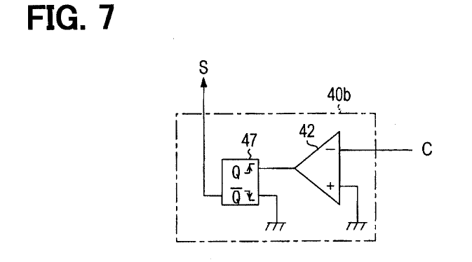

In cases where the reactor current IL is detected only during an on-period of the switching element 14 as the present embodiment, the control signal generation section 40a may be replaced by a control signal generation section 40b that includes the comparator 42 and a one-shot multivibrator 47 as shown in FIG. 7.

In the control signal generation section 40b, the switching signal S is normally at the high level. In other words, the switching element 14 is normally on. When the command value C falls below a threshold value (e.g., zero) of the comparator 42, a signal is input to the one-shot multivibrator 47, and the switching signal S transitions to the low level, that is, the switching element 14 is turned off. After a predetermined period has elapsed, the signal of the one-shot multivibrator 47 changes, and the switching signal S automatically transitions to the high level, that is, the switching element 14 is turned on. In other words, because the switching element 14 is automatically changed from off to on, the control signal generation section 40b can function similarly to the control signal generation section 40a. However, in the control signal generation section 40b, an off-period of the switching element 14 is fixed and only an on-period changes depending on the command value C. Thus, the on-off period is unfixed differently from the control signal generation section 40a.

### Fourth Embodiment

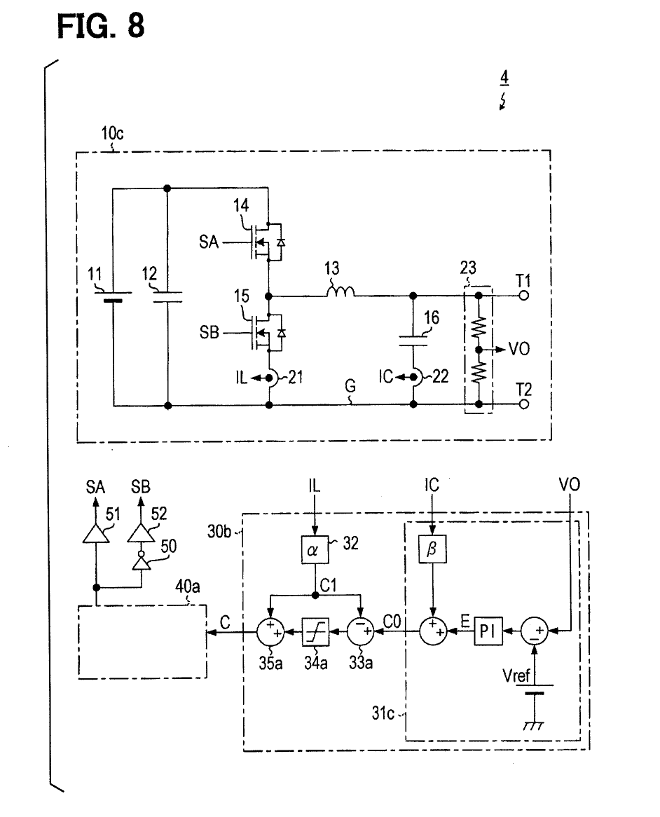

A switching regulator 4 according to a fourth embodiment of the present disclosure will be described below. As shown in FIG. 8, the switching regulator 4 includes a power feed circuit section 10c, a command value generation section 30b, the control signal generation section 40a, the inverting circuit 50, and the buffers 51, 52. Regarding configurations which have already been described above, the same reference numerals are attached, and a description will be omitted. A portion different from the above-described embodiment will be mainly described.

The power feed circuit section 10c has a configuration similar to the power feed circuit section 10 in the switching regulator 1 except that the current detector 21 is disposed on the current path from the switching element 15 to the ground line G not on the ground line G. In other words, the reactor current IL can be detected only when the switching element 15 is on.

The command value generation portion 30b basically has a configuration similar to the command value generation portion 30. However, the command value generation portion 30b is configured such that the smaller the output voltage VO becomes compared with the reference voltage Vref and the more significantly the load power changes in the increasing direction, the smaller the command value C becomes in a manner opposite from the command value generation portion 30. The command value C is inverted compared with the third embodiment because the switching elements 14, 15 that operates at detection of the reactor current IL are different from each other and the switching elements 14, 15 operate complementary.

Specifically, in the reference command value generation portion 31c, the polarity at calculating the deviation of the output voltage VO with respect to the reference voltage Vref and the polarity of the capacitor current IC reflected on the error signal E are reversed polarities compared with the reference command value generation portion 30.

In addition, adders 33a, 35b are set such that polarities at adding the pseudo command value C1 are reversed polarities compared with the adders 33, 35 in the reference command value generation portion 30. When an input value C0−C1 of a limiter 34a exceeds an upper limit value limited by the limiter 34a, a switching signal S generated at the control signal generation section 40a is adjusted to have such a duty ratio that the reactor current IL does not fall below a lower limit value. When the input value C0−C1 of the limiter 34 falls below a lower limit value limited by the limiter 34a, the switching signal S generated at the control signal generation section 40a is adjusted to have such a duty ratio that the reactor current IL does not exceed an upper limit value.

As described above, the switching regulator 4 operates similarly to the switching regulator 3 and can achieve effects similar to the switching regulator 1.

### Modification

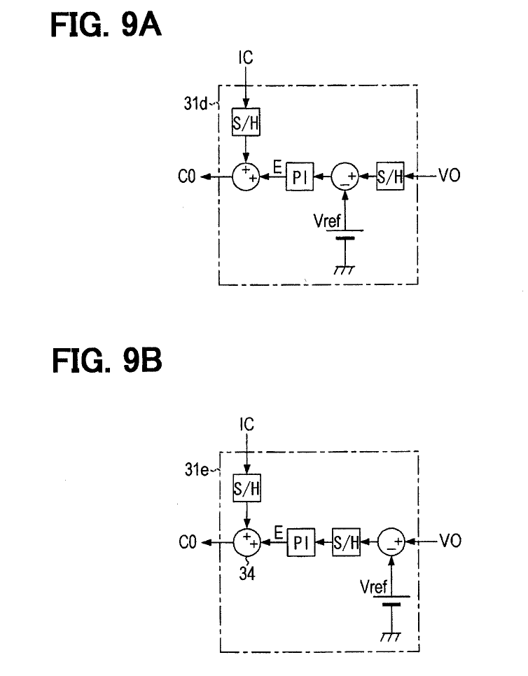

In the present embodiment, instead of the reference command value generation portion 31c, a reference command value generation portion 31d shown in FIG. 9A or a reference command value generation portion 31e shown in FIG. 9B may be used.

The reference command value generation portion 31d samples the output voltage VO and the capacitor current IC while the switching element 15 is on. After that, while the switching element 15 is off and the switching element 14 is on, the reference command value generation portion 31d holds sampling values.

The reference command value generation portion 31e samples and holds the deviation of the output voltage VO from the reference voltage Vref instead of sampling and holding the output voltage VO.

The reference command value generation portions 31d, 31e perform sampling and holding at a constant timing synchronized with the switching timing of the switching elements 14, 15. Accordingly, the reference command value generation portions 31d, 31e can also function as low pass filter (LPF) that remove a ripple included in the capacitor current IC and the output voltage VO which are detection objects.

In the present embodiment, the command value generation section 30 may be used instead of the command value generation portion 30b and the inverting circuit 50 may be disposed adjacent to the buffer 51 from which the switching signal SA is output and not to the buffer 52 from which the switching signal SB is output.

### Fifth Embodiment

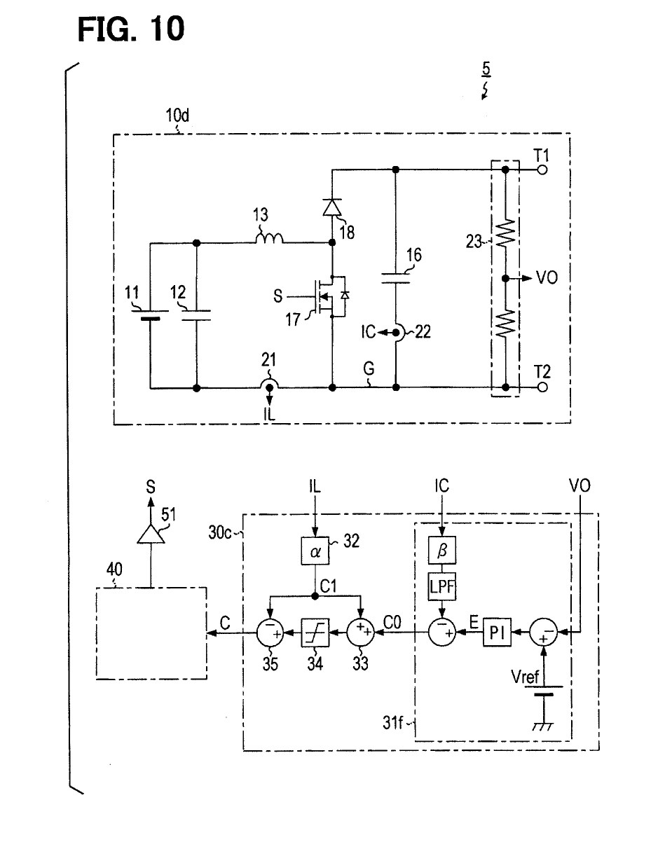

A switching regulator 5 according to a fifth embodiment of the present disclosure will be described. As shown in FIG. 10, the switching regulator 5 includes a power feed circuit section 10d, a command value generation section 30c, the control signal generation section 40, and the buffer 51. The inverting circuit 50 and the buffer 52 are omitted and the power feed circuit section 10c operates based on the switching signal S that is same as the switching signal SA. Regarding configurations which have already been described above, the same reference numerals are attached, and a description will be omitted. A portion different from the above-described embodiment will be mainly described.

Compared with the power feed circuit section 10, the power feed circuit section 10d includes a switching element 17 and a diode 18 instead of the switching elements 14, 15. The switching element 17 connects or disconnects a path from the choke coil 13 to the ground line G connected to the negative electrode of the DC power source 11 based on the switching signal S. The diode 18 is connected between an end of the choke coil 13 connected with the switching element 17 and the output terminal T1 on the positive electrode side. The diode 18 has a forward direction in a direction from the choke coil 13 toward the output terminal T1.

The current detector 21 that detects the reactor current IL is disposed on the ground line G between a position where the switching element 17 is connected and the negative electrode of the DC power source 11. In the power feed circuit section 10d having the above-described configuration, while the switching element 17 is on, electric current flows in the closed circuit formed by the DC power source 11 and the choke coil 13 (hereafter, this state is referred to as a first operation state), and electromagnetic energy is stored in the choke coil 13. On the other hand, while the switching element 17 is off, electric current flows in a closed circuit formed by the DC power source 11, the choke coil 13, the diode 18, and the load connected between the output terminals T1, T2. Hereafter, this state is referred to as a second operation state. At this time, a voltage obtained by adding the voltage across the choke coil 13 to the source voltage of the DC power source 11 (i.e., a voltage boosted by the source voltage) is applied through the diode 18 to the load connected between the output terminals T1, T2. In the other words, the power feed circuit section 10d operates as a boost converter.

The command value generation portion 30c includes a reference command value generation portion 31f. The reference command value generation portion 31f treats a value corresponding to the capacitor current IC multiplied by the factor β with a low pass filter (LPF) and then subtracts the value from the output of the PI control.

The switching regulator 5 operating as the boost converter needs the LPF because a ripple of the capacitor current IC is larger than a switching regulator operating as a buck converter. However, a time constant of the LPF may be sufficiently smaller than a time constant of the PI control.

As described above, the switching regulator 5 includes the power feed circuit section 10d different from the power feed circuit section 10 in the switching regulator 1. However, the switching regulator 5 generates the command value C used for controlling the switching signal S in a manner similar to the switching regulator 1. Thus, the switching regulator 5 can achieve effects similar to the switching regulator 1.

### Sixth Embodiment

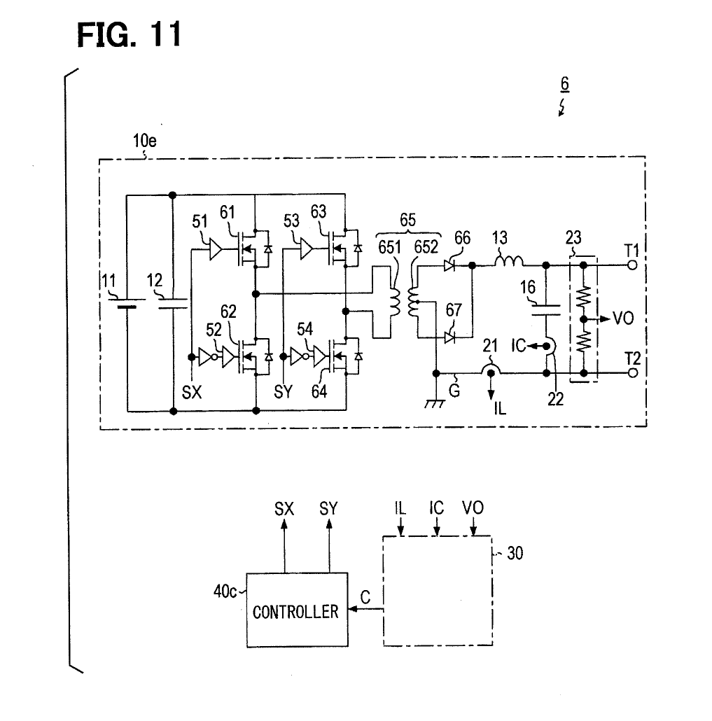

A switching regulator 6 according to a sixth embodiment of the present disclosure will be described below. As shown in FIG. 11, the switching regulator 6 includes a power feed circuit section 10e, a command value generation section 30, the control signal generation section 40c, and buffers 51-54. Regarding configurations which have already been described above, the same reference numerals are attached, and a description will be omitted. A portion different from the above-described embodiment will be mainly described.

Compared with the power feed circuit section 10d, the power feed circuit section 10e includes switching elements 61-64, a transformer 65, and diodes 66, 67 instead of the switching elements 14, 15. The switching elements 61-64 form a bridge circuit converting the output of the DC power source 11 to an alternating-current (AC) output. The transformer 65 includes a primary coil 651 and a secondary coil 652. The primary coil 651 is connected to the bridge circuit. The diodes 66, 67 form a rectifier circuit that rectifies an output of the secondary coil 652 of the transformer 65. The output of the rectifier circuit is supplied to the choke coil 13.

The current detector 21 detecting the reactor current IL is disposed on the ground line G from the output terminal T2 to a neutral point of the secondary coil 652. The switching elements 61, 62 complementarily operate based on a signal SX. The switching elements 63, 64 complementarily operate based on a switching signal SY. In other words, the power feed circuit section 10e has a structure of so-called insulated forward converter.

The switching element 61 is on when the switching signal SX is at the high level and the switching element 63 is on when the switching signal SY is on. Signal levels of the switching signals SX, SY are expressed by (SX, SY).

In the feed circuit section 10e, a forward voltage is applied to the primary coil 651 when (SX, SY)=(high, low), and a reverse voltage is applied to the primary coil 651 when (SX, SY)=(low, high). When (SX, SY)=(high, high) or (SX, SY)=(low, low), zero voltage is applied.

Thus, when the signal levels of the switching signals SX, SY repeatedly changes in the following order; (high, low), (high, high), (low, high), and (low, low) and a duty ratio of a period of (high, low) or (low, high) (hereafter, referred to as an effective period) and a period of (high, high) or (low, low) (hereafter, referred to as ineffective period) is controlled, a desired electric power can be supplied through the transformer 65 to a circuit connected to the secondary coil 652.

The control signal generation section 40c includes a controller that generates the switching signals SX, SY based on the command value C. The control signal generation section 40c switches the signal levels of the switching signals SX, SY such that the larger the command value C becomes, the larger the duty ratio of the effective period becomes.

As described above, the switching regulator 6 includes the power feed circuit section 10d different from the power feed circuit section 10 in the switching regulator 1. However, the switching regulator 5 generates the command value C used for controlling the switching signals SX, SY in a manner similar to the switching regulator 1. Thus, the switching regulator 6 can achieve effects similar to the switching regulator 1.

### Other Embodiments

Although the present disclosure has been fully described in connection with the exemplary embodiments thereof with reference to the accompanying drawings, it is to be noted that various changes and modifications will become apparent to those skilled in the art.

In the switching regulators in the above-described embodiments, each of the power feed circuit section has a structure of a buck converter, a boost converter, or an insulated forward converter. However, each of the power feed circuit section may have any configuration if a current mode control can be applied.

The technologies described in the respective embodiments may be replaced by each other within a range not conflicting to each other. In the present case, the polarities of the signals may be appropriately changed in accordance with the control method. Each of the command value generation sections and each of the control signal generation sections may have other operationally-equivalent circuit configurations. For example, in FIG. 1, the adder 35 is used as a removing section that removes a value corresponding to the pseudo command value C1 from the output of the limiter 34, and the adder 35 adds the pseudo command value C1 having the reversed polarity to the output of the limiter 34. Instead of the adder 35, another adder (not shown) that adds the pseudo command value C1 to the output of the saw-tooth wave generation circuit 41 may be used. Also in the present case, the comparison at the comparator 42 is equivalent in content. Thus, effects similar to each of the above-described embodiments can be achieved.

What is claimed is:

1. A switching regulator comprising:
a power feed circuit section including a reactor, a capacitor, and a switching circuit, the reactor connected to a power supply source, the capacitor connected between two output terminals, the capacitor charged and discharged by electric current supplied from the reactor, the switching circuit controlling power supply from the power supply source to the reactor;
a reference command value generation portion generating a reference command value based on a physical quantity representing a state of the power feed circuit section;
an adder adding a pseudo command value depending on a reactor current flowing in the reactor to the reference command value;
a limiter limiting at least one of an upper limit value and a lower limit value of an adding result of the adder;
a removing section removing a value corresponding to the pseudo command value from a processing result of the limiter; and
a control performing section controlling a duty ratio of the switching circuit using a processing result of the removing section as a command value.

2. The switching regulator according to claim 1,
wherein the reference command value generation portion uses an output voltage generated between the output terminals and a capacitor current that flows during charge and discharge of the capacitor, or a control signal reflecting on the output voltage and the capacitor current as the physical quantity, and
wherein the control performing section controls the duty ratio of the switching circuit such that the larger the output voltage becomes compared with a predetermined target voltage or the more the capacitor current flows in a direction charging the capacitor, the smaller the reactor current becomes, and the smaller the output voltage becomes compared with the predetermined target voltage or the more the capacitor current flows in a direction discharging the capacitor, the larger the reactor current becomes.

3. The switching regulator according to claim 2,
wherein the reference current generation portion uses a result of differentiating the output voltage as the capacitor current.

4. The switching regulator according to claim 1,
wherein the switching circuit has a structure of a buck converter that switches a first operation state and a second operation state according to the duty ratio,
wherein the power supply source, the reactor, and a load connected to the output terminals form a closed circuit in the first operation state, and
wherein the reactor and the load connected to the output terminals form a closed circuit in the second operation state.

5. The switching regulator according to claim 1,
wherein the switching circuit has a structure of a boost converter that switches a first operation state and a second operation state according to the duty ratio,
wherein the power supply source and the reactor form a closed circuit in the first operation state, and
wherein the power source, the reactor, and a load connected to the output terminals form a closed circuit in the second operation state.

6. The switching regulator according to claim 1,
wherein the power supply source includes a primary coil connected to a direct-current power source and a secondary coil forming a closed circuit with the reactor and a load connected to the output terminals,
wherein the switching circuit has a configuration as an insulated forward converter that switches a first operation state and a second operation state according to the duty ratio, and
wherein a positive or negative voltage is applied to primary coil in the first operation state and zero voltage is applied to the primary coil in the second operation state.
